(19) United States
(12) Patent Application Publication
(10) Pub. No.: US 2025/0122102 A1
(43) Pub. Date: Apr. 17, 2025

(54) BIAS-FREE DRIVEN ION ASSISTED PHOTOELECTROCHEMICAL WASTEWATER TREATMENT SYSTEM AND METHOD

(71) Applicant: Shanghai University, Shanghai (CN)

(72) Inventors: Liang TANG, Shanghai (CN); Qi DANG, Shanghai (CN); Jiajun WANG, Shanghai (CN); Minghong WU, Shanghai (CN)

(21) Appl. No.: 18/991,865

(22) Filed: Dec. 23, 2024

Related U.S. Application Data
(63) Continuation of application No. PCT/CN2023/137679, filed on Dec. 8, 2023.

(30) Foreign Application Priority Data
Jun. 18, 2023 (CN) 202310723186.2

(51) Int. Cl. C02F 1/461; C02F 1/30; C02F 1/467; C02F 101/30; C02F 101/34; C02F 101/38; C02F 103/30; C02F 103/34; C03C 17/25; C25D 9/04

(52) U.S. Cl. CPC C02F 1/46109; C02F 1/30; C02F 1/4674; C03C 17/25; C03C 17/256; C25D 9/04; C02F 2001/46142; C02F 2101/30; C02F 2101/34; C02F 2101/38; C02F 2103/30; C02F 2103/343; C02F 2305/023; C02F 2305/10; C03C 2217/212; C03C 2217/284; C03C 2217/71; C03C 2217/94; C03C 2218/111; C03C 2218/115; C03C 2218/31; C03C 2218/32

(57) ABSTRACT

A bias-free driven ion-based photoelectrochemical wastewater treatment system and method is disclosed. Through an ion-coupled photogenerated electron-assisted photocatalytic oxidation-reduction pathway, the system achieves efficient treatment of high-salinity wastewater. The system employs electron-ion receptor materials as the counter electrode, providing reaction sites to drive the coupling of photogenerated electrons and cation transfer. Additionally, the voltage generated by the system directly drives hole oxidation to produce strong oxidizing free radicals. Furthermore, this ion-based photoelectrochemical system demonstrates excellent degradation performance in high-concentration chloride media. This indicates that, in addition to cations (such as Na+) helping to accelerate the electron transfer rate, the presence of Cl− further enables efficient and sustainable wastewater treatment. The concept proposed in this invention emphasizes the potential for using abundant sodium chloride in seawater as an inexpensive additive for wastewater treatment.

### CROSS-REFERENCE TO RELATED APPLICATIONS

This application is a continuation of International Application No. PCT/CN2023/137679, filed on Dec. 8, 2023, entitled “BIAS-FREE DRIVEN ION ASSISTED PHOTOELECTROCHEMICAL WASTEWATER TREATMENT SYSTEM AND METHOD”, which claims priority of Chinese Patent Application No. 202310723186.2, filed on Jun. 18, 2023 in the China National Intellectual Property Administration (CNIPA), the entire contents of which is hereby incorporated by reference in its entireties.

### TECHNICAL FIELD

The present invention relates to the field of photoelectrocatalysis, especially to a bias-free driven ion-based photoelectrochemical wastewater treatment system and method.

### BACKGROUND

Industries such as textiles, pharmaceuticals, and pesticides generate large amounts of wastewater containing significant amounts of inorganic salts and difficult-to-degrade organic compounds. For example, in the textile industry, up to 2 tons of inorganic salts (NaCl and Na₂SO₄) are used to dye one ton of fabric, and approximately 200 to 400 cubic meters of fresh water is consumed for every ton of final product, resulting in wastewater containing dyes and inorganic salts. Photoelectrochemical (PEC) technology, which combines the advantages of electrocatalysis and photocatalysis, is considered one of the most promising and environmentally friendly methods for pollutant degradation. Generally, a typical PEC system consists of a photoanode, a cathode, an applied bias potential, a light source, and an electrolyte. In this system, semiconductor photocatalysts (typically TiO₂, WO₃, and BiVO₄) are supported on conductive substrate such as fluorine-doped tin oxide (FTO), titanium foil, and nickel foam as the photoanode, with Pt commonly used as the cathode. When light with energy equal to or greater than the bandgap of the semiconductor is incident on the photoanode, electrons and holes are generated. Under the applied bias voltage, photogenerated electrons transfer from the photoanode to the electron acceptor cathode, facilitating the reduction of H₂O to H₂, while the holes left on the photoanode are used to oxidize H₂O to O₂ or hydroxyl radicals (·OH), which have the ability to oxidize organic pollutants into small molecules such as CO₂ and H₂O. Fundamentally, the efficiency of photogenerated charge separation is a key factor determining the photoelectrosynthetic performance. Currently, to improve the charge separation efficiency, methods such as heterogeneous structure construction, nanostructure engineering, and cocatalyst modification are mainly employed to enhance the charge separation efficiency of photoelectrodes, thereby improving their electrochemical performance. However, research on cathode materials for PEC systems is relatively limited, and most efforts focus on altering the reaction pathway for catalyzing water splitting. Considering the presence of large amounts of inorganic salts in wastewater, we propose the introduction of electron-ion coupling materials as cathodes, utilizing ions from the wastewater to couple with photogenerated electrons to assist charge transfer and storage, thereby achieving the simultaneous removal of organic and inorganic pollutants without consuming energy.

Based on the above concept, the present invention provides a bias-free driven ion-based photoelectrochemical wastewater treatment system and method.

### SUMMARY

The objective of the present invention is to address the issues of the unsustainability of the required applied bias voltage in photoelectrochemical systems and the low degradation efficiency of organic pollutants caused by the photogenerated charge separation efficiency. The invention provides a bias-free driven ion-based photoelectrochemical wastewater treatment system and method. This method can significantly enhance the degradation and mineralization rate of organic pollutants under bias-free conditions. The method is straightforward, with simple processing steps, mild reaction conditions, and easy scalability for production.

To address the above issues, the following technical solution is adopted.

A bias-free driven ion-based photoelectrochemical wastewater treatment system, including a photoanode, a cathode, a quartz electrolytic cell containing an electrolyte, and a xenon lamp light source simulating the solar spectrum. The photoanode is an electrode made of an oxygen vacancies-enriched N-type semiconductor, and the cathode is an electrode made of an electron-ion receptor material. The photoanode and cathode are inserted at both ends of the quartz electrolytic cell, and an external circuit wire is provided between the photoanode and cathode.

When illuminated, the photoanode is excited by the simulated light source from the xenon lamp to generate electron-hole pairs. The cathode made of electron-ion receptor material has the function of simultaneously receiving coupled electrons and ions. Photogenerated electrons quickly flow to the cathode via the external circuit while coupling with cations in the electrolyte to achieve the transfer of photogenerated electrons.

A method for bias-free driven ion-based photoelectrochemical wastewater treatment, including the following steps:

(1) Selection and preparation of a photoanode: Selecting an oxygen vacancies-enriched N-type semiconductor and preparing a photoelectrode made of the oxygen vacancies-enriched N-type semiconductor via a hydrothermal or electroplating method.

(2) Selection and preparation of a cathode: Selecting a material that has the function of simultaneously embedding ions and electrons, and preparing the cathode made of electron-ion receptor material by spin coating.

(3) Installation of a reaction device: Inserting the photoanode and cathode into two ends of a quartz electrolytic cell containing an electrolyte, where the quartz electrolytic cell holds organic wastewater; providing an external circuit wire between the photoanode and cathode to form the reaction device.

(4) Perform photoelectrochemical reaction using the reaction device: Illuminating the photoanode with the xenon lamp light source simulating the solar spectrum; the simulated light source from the xenon lamp excites the generation of electron-hole pairs; the cathode, made of electron-ion receptor material, simultaneously receives coupled electrons and ions; photogenerated electrons quickly flow to the cathode through the external circuit while coupling with cations in the electrolyte to transfer photogenerated electrons; the holes left on the photoanode undergo water oxidation to form strong oxidizing agents (·OH); then reacting with chloride ions to form free chlorine, which is oxidized by h⁺, ·OH, or ·Cl to form ·ClO, thereby oxidizing and mineralizing organic pollutants in the wastewater.

Furthermore, in step (1), the selection process of the photoanode is as follows: Selecting the oxygen vacancies-enriched N-type semiconductor as the photoanode; the photogenerated holes in the valence band of the photoanode are more positive than the oxidation potential of halide ions to halogen radicals.

Furthermore, the process for preparing the photoanode using a hydrothermal method in step (1) is as follows:

(a) Preparation of an oxygen vacancies-enriched titanium dioxide conductive glass photoanode using the hydrothermal method: Ultrasonically cleaning FTO substrate in acetone, ethanol, and deionized water for 10-30 minutes each, then drying the cleaned FTO substrate in an oven at 60-80° C.; after drying, testing the dried FTO substrate with a digital multimeter and labeling a conductive side for later use. Next, adding titanium tetraisopropoxide to a mixed solution of deionized water and concentrated hydrochloric acid. After stirring, transferring the solution to a high-pressure vessel. Tilting the FTO substrate and placing the FTO substrate high-pressure vessel with the conductive side facing down. Transferring the high-pressure vessel to a constant temperature oven and maintain it at 60-80° C. for 4-8 hours before removing it. Once the high-pressure vessel cools to room temperature, fetching the FTO substrate with TiO₂ growth, rinsing the FTO substrate alternately with deionized water and ethanol 2-3 times, and drying the rinsed FTO substrate in an oven.

(b) Preparation of a 0.2 M titanium tetrachloride solution: Using concentrated hydrochloric acid (36%-38%) as the solvent and adding titanium tetrachloride to the concentrated hydrochloric acid to form the 0.2 M titanium tetrachloride solution.

(c) Immersing the FTO substrate with TiO₂ growth obtained in step (a) into the 0.2 M titanium tetrachloride solution prepared in step (b); sealing the bottle and transfer the bottle to an oven for 0.5-1.5 hours; taking out the FTO substrate and washing the FTO substrate with 99.9% anhydrous ethanol before blowing dry.

(d) Placing the TiO₂-coated FTO substrate from step (c) into a crucible, transferring the crucible to a muffle furnace, and annealing the FTO substrate at 500-600° C. for 2.5-3.5 hours with a heating rate of 5° C./min; after natural cooling, the oxygen vacancies-enriched TiO₂ photoanode is obtained.

Furthermore, the process for preparing the photoanode using an electroplating method in step (1) is as follows:

(a) Preparation of an oxygen vacancies-enriched bismuth vanadate conductive glass photoanode using the hydrothermal method: Ultrasonically cleaning the FTO substrate in acetone, ethanol, and deionized water for 10-30 minutes each, then dry the cleaned FTO substrate in an oven at 60-80° C.; after drying, testing the FTO substrate with a digital multimeter and label the conductive side of the FTO substrate for later use; next, mixing 0.4 M potassium iodide solution with concentrated nitric acid solution to adjust the pH to 1.6; then, adding 0.04 M Bi(NO₃)₃·5H₂O, stirring strongly, and obtaining a transparent KI/Bi(NO₃)₃ solution.

(b) Adding p-benzoquinone into the KI/Bi(NO₃)₃ solution obtained in step (a); stirring, and then filtering with a water-based filter membrane and syringe; in a three-electrode system consisting of saturated mercury and Pt electrode and FTO substrate, applying a −0.144 V_{SCE} bias for 90-150 seconds to electrodeposit a BiOI film.

(c) Preparing a 0.2 M VO(acac)₂ solution in DMSO (Dimethyl Sulphoxide) and obtain a clear solution after ultrasonic treatment; dropping 55 μL/cm² of the DMSO solution onto the BiOI film from step (b) and placing the BiOI film flat in a rectangular quartz boat without a lid; transferring the rectangular quartz boat to a muffle furnace and heat at a rate of 2° C./min to 400-500° C.; maintaining for 1.5-2.5 hours and then allow rectangular quartz boat to cool naturally.

(d) Immersing the electrode obtained in step (c) in 1.0 M KOH, stirring the KOH slowly for 10-20 minutes to remove the byproduct V₂O₅ impurities from the electrode surface, resulting in an oxygen vacancies-enriched bismuth vanadate photoanode.

Furthermore, in step (2), the process for selecting and preparing the cathode is as follows:

(2.1) Selection of the electron-ion receptor cathode: Selecting a material capable of simultaneously embedding ions and electrons, where the Gibbs free energy for ion embedding in the cathode material is less than zero.

(2.2) Preparation of the electron-ion receptor cathode: Preparing the cathode using the spin-coating method; using carbon cloth as a conductive substrate, and mixing the electron-ion receptor cathode material, conductive carbon black, and polyvinylidene fluoride in a (6-8):(1-3):1 ratio in an agate mortar; adding N-methyl-2-pyrrolidone into the agate mortar and grinding the electron-ion receptor cathode material, the conductive carbon black, the polyvinylidene fluoride, and the N-methyl-2-pyrrolidone in the agate mortar to form a slurry; then evenly coating the slurry onto the conductive carbon cloth and dry the conductive carbon cloth in a vacuum oven for 10-15 hours. The cathode is all prepared.

Furthermore, in step (3), the electrolyte is a solution of 0.01-2 M sodium chloride and organic pollutants.

Furthermore, in step (4), the simulated light source has an AM1.5 spectrum and an irradiance of 100 mW/cm², equivalent to standard solar irradiance.

Furthermore, the cathode is the positive material of a water-based ion battery such as Na⁺, K⁺, or NH₄⁺ ion battery.

Furthermore, the photoanode is an electrode of oxygen vacancies-enriched TiO₂, WO₃, and BiVO₄, optimized through the preparation process.

Due to the adoption of the above technical solution, the following advantages are achieved:

The present invention provides a bias-free driven ion-based photoelectrochemical wastewater treatment system and method. It introduces a novel ion-assisted photoelectrochemical system, namely, an ion-coupled electron transfer process. This system includes inorganic electron-ion receptor cathode materials, which can reversibly store and release electrons and ions (such as Na⁺, K⁺, or NH₄⁺), providing reaction sites for the coupling of photogenerated electrons and ions. Furthermore, the spontaneous high potential difference between the electron-ion receptor cathode and the photoelectrode not only significantly increases the electron transfer rate but also drives the generation of highly active free radicals under zero bias voltage. Particularly for wastewater with a high chloride content, the Cl⁻ in the solution can be oxidized to active chlorine (HCIO), which can catalyze the generation of ·OH, exhibiting stronger oxidation power. This indicates that the abundant sodium chloride in seawater can serve as an inexpensive enhancer for future PEC wastewater treatment systems, providing a pathway for the engineering design of low-carbon and sustainable wastewater treatment processes. Overall, the invention offers a new approach for the design of high-performance PEC systems for sustainable and low-carbon wastewater treatment and resource recovery.

In addition, the system uses a cathode with electron-ion coupling functionality, which, on one hand, couples the transfer of photogenerated electrons to improve hole-electron separation efficiency. On the other hand, the potential difference between the cathode and the photoelectrode is sufficient to replace the applied bias voltage typically required in conventional photoelectrochemical systems for chlorine radical generation, reducing the energy consumption of the system and enhancing the sustainability of traditional photoelectrochemical systems.

Compared to the prior art, the present invention, based on an oxygen vacancies-enriched titanium dioxide photoanode, effectively improves electron-hole separation efficiency in the degradation of organic pollutants in water mediated by chlorine radicals. This leads to an improved system photoelectrochemical conversion efficiency.

### BRIEF DESCRIPTION OF DRAWINGS

The present invention will be further explained with reference to the accompanying drawings:

FIG. 1 is a schematic diagram of the principle structure of a bias-free driven ion-based photoelectrochemical wastewater treatment system according to one embodiment of the present invention.

FIG. 2 is a comparison chart of the degradation effect of the organic pollutant methylene blue between Embodiment 1 of the present invention and a photoelectrochemical system in the prior art.

FIG. 3 is a comparison chart of the degradation effect of the organic pollutant methylene blue in different chloride ion electrolyte concentrations in Embodiment 2 of the present invention.

FIG. 4 is a comparison chart of the degradation effect of the organic pollutant carbamazepine between Embodiment 3 of the present invention and a photoelectrochemical system in the prior art.

### DESCRIPTION OF EMBODIMENTS

To make the objectives, technical solutions, and advantages of the present invention clearer, the following provides a more detailed explanation of the invention through the accompanying drawings and embodiments. However, it should be understood that the specific embodiments described here are for illustrative purposes only and are not intended to limit the scope of the present invention. Furthermore, descriptions of known structures and technologies are omitted to avoid unnecessary confusion of the concepts of the present invention.

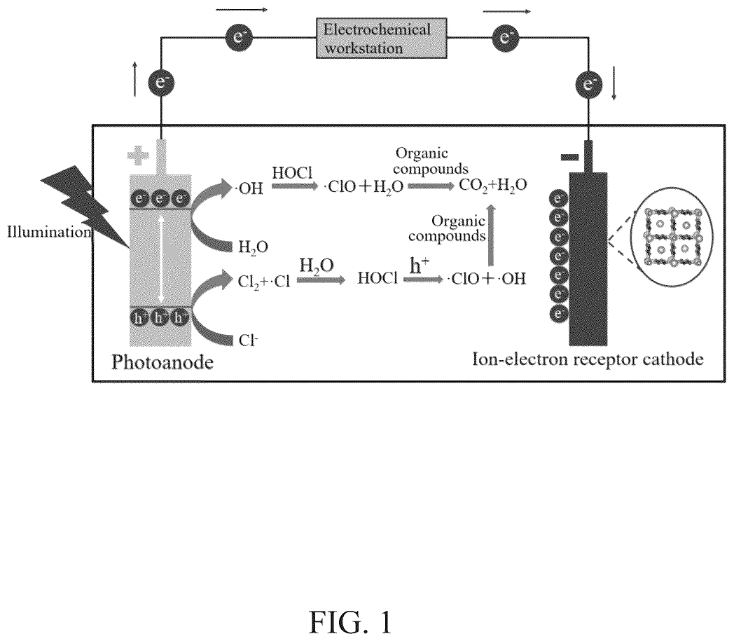

Referring to FIG. 1, a bias-free driven ion-based photoelectrochemical wastewater treatment system includes a photoanode, a cathode, a quartz electrolytic cell containing an electrolyte, and a xenon lamp light source simulating the solar spectrum. The photoanode is an electrode made of an oxygen vacancies-enriched N-type semiconductor, and the cathode is an electrode made of electron-ion receptor material. The photoanode and cathode are inserted at both ends of the quartz electrolytic cell, and an external circuit wire is provided between the photoanode and cathode.

When illuminated, the photoanode is excited by the simulated light source from the xenon lamp to generate electron-hole pairs. The cathode made of electron-ion receptor material has the function of simultaneously receiving coupled electrons and ions. Photogenerated electrons quickly flow to the cathode via the external circuit while coupling with cations in the electrolyte to achieve the transfer of photogenerated electrons.

A method for bias-free driven ion-based photoelectrochemical wastewater treatment, including the following steps:

(1) Selection and preparation of the photoanode: Selecting an oxygen vacancies-enriched N-type semiconductor and preparing a photoelectrode made of the oxygen vacancies-enriched N-type semiconductor using a hydrothermal or electroplating method.

(2) Selection and preparation of the cathode: Selecting a material capable of simultaneously embedding ions and electrons, and preparing the cathode made of electron-ion receptor material using the spin-coating method.

(3) Installation of the reaction device: Inserting the photoanode and cathode into two ends of a quartz electrolytic cell containing an electrolyte, where the cell holds organic wastewater; providing an external circuit wire between the photoanode and cathode to form the reaction device.

(4) Perform the photoelectrochemical reaction using the reaction device: Illuminating the photoanode with the xenon lamp light source simulating the solar spectrum; the simulated light source from the xenon lamp excites the generation of electron-hole pairs; the cathode made of electron-ion receptor material has the function of simultaneously receiving coupled electrons and ions; photogenerated electrons quickly flow to the cathode through the external circuit while coupling with cations in the electrolyte to transfer photogenerated electrons; the holes left on the photoanode undergo water oxidation to form strong oxidizing agents (·OH), which then reacting with chloride ions to form free chlorine; the free chlorine is further oxidized by h⁺, ·OH, or ·Cl to form ·ClO, thereby oxidizing and mineralizing organic pollutants in the wastewater.

As a further explanation of this embodiment, in step (1), the process for selecting the photoanode is as follows: Selecting an oxygen vacancies-enriched N-type semiconductor as the photoanode. The photogenerated holes in the valence band (VB) of the photoanode are more positive than the oxidation potential of halide ions to halogen radicals, enabling the generation of chlorine radicals under solar light.

As a further explanation of this embodiment, the process for preparing the photoanode using the hydrothermal method in step (1) is as follows:

(a) Preparation of an oxygen vacancies-enriched titanium dioxide (TiO₂) conductive glass using the hydrothermal method: Ultrasonically cleaning FTO substrate in acetone, ethanol, and deionized water for 10-30 minutes each. Preferably, ultrasonically cleaning in acetone for 10 minutes, in ethanol for 10 minutes, and in deionized water for 10 minutes. Then, drying in an oven at 60-80° C., preferably at 70° C. After drying, testing with a digital multimeter and labelling the conductive side for later use. FTO refers to fluorine-doped SnO₂ conductive glass.

Next, adding 0.5 mL of titanium tetraisopropoxide to a mixed solution formed by 10 mL deionized water and 10 mL concentrated hydrochloric acid. After stirring for 10 minutes, transfer the solution to a 50 mL high-pressure vessel. Then, tilting the FTO and placing it in the high-pressure vessel with the conductive side facing down. Transferring the high-pressure vessel to a constant temperature oven and maintaining it at 170° C. for 4-8 hours, preferably 5 hours. After cooling to room temperature, fetching the FTO substrate with TiO₂ growth, rinsing alternately with deionized water and ethanol 2-3 times, and drying in an oven. Preferably, rinsing 3 times with deionized water and ethanol.

(b) Preparation of a 0.2 M titanium tetrachloride (TiCl₄) solution: To prevent hydrolysis of TiCl₄, using concentrated hydrochloric acid (36%-38%) as the solvent; adding 1 mL of TiCl₄ to 47.2 mL of concentrated hydrochloric acid to obtain a 0.2 M TiCl₄ solution.

(c) Immersing the FTO substrate with TiO₂ growth obtained in step (a) into the 0.2 M TiCl₄ solution prepared in step (b); sealing the bottle and transfer the bottle to an oven for 0.5-1.5 hours, preferably at 80° C. for 1 hour. Finally, washing with 99.9% anhydrous ethanol and blowing dry.

(d) Placing the TiO₂-coated FTO substrate from step (c) into a crucible, transfer the crucible to a muffle furnace, and anneal the TiO₂-coated FTO substrate at 500-600° C. for 2.5-3.5 hours, preferably at 550° C. for 3 hours. Controlling the heating rate to 5° C./min and allowing it to cool naturally to obtain the oxygen vacancies-enriched TiO₂ photoanode.

As a further explanation of this embodiment, the process for preparing the photoanode using the electroplating method in step (1) is as follows:

(a) Preparation of an oxygen-vacancies-enriched bismuth vanadate (BiVO₄) conductive glass photoanode using the hydrothermal method: Ultrasonically cleaning FTO substrate in acetone, ethanol, and deionized water for 10-30 minutes each. Preferably, ultrasonically cleaning in acetone for 10 minutes, in ethanol for 10 minutes, and in deionized water for 10 minutes. Then, drying in an oven at 60-80° C., preferably at 70° C. After drying, testing with a digital multimeter and labelling the conductive side for later use. FTO refers to fluorine-doped SnO₂ conductive glass.

Then, mixing 491 mL of 0.4 M potassium iodide solution with 920 μL concentrated nitric acid and 9 mL water to adjust the pH to 1.6. Finally, adding 0.04 M Bi(NO₃)₃·5H₂O and stirring strongly to obtain a clear KI/Bi(NO₃)₃ solution.

(b) Taking out 50 mL of the KI/Bi(NO₃)₃ solution obtained in step (a), adding 0.3623 g (65.7 mM) p-benzoquinone, stirring for 20 minutes, then filter using a water-based filter membrane (0.2 μm) and syringe. In a three-electrode system with saturated mercury and Pt electrodes and FTO, applying a −0.144 V_{SCE} bias for 90-150 seconds to electrodeposit a BiOI film. Preferably, the bias deposition time is 120 seconds.

(c) Preparing a 0.2 M VO(acac)₂ solution in DMSO and obtain a clear solution after ultrasonic treatment. Dropping 55 μL/cm² of this DMSO solution onto the BiOI film prepared in step (b), placing it flat in a rectangular quartz boat without a lid, and transfer the rectangular quartz boat to a muffle furnace. Heating at a rate of 2° C./min to 400-500° C. and maintaining for 1.5-2.5 hours, then cooling naturally. Preferably, heat to 450° C. and maintain for 2 hours.

(d) Immersing the electrode obtained in step (c) in 1.0 M KOH, stirring slowly for 10-20 minutes, preferably 15 minutes, to remove the byproduct V₂O₅ impurities from the electrode surface. This results in the oxygen vacancies-enriched bismuth vanadate photoanode.

As a further explanation of this embodiment, the process for selecting and preparing the cathode in step (2) is as follows:

(2.1) Selection of the electron-ion receptor cathode: Selecting a material that simultaneously embeds both ions and electrons, where the Gibbs free energy for ion embedding in the cathode material must be less than zero (ΔG<0).

(2.2) Preparation of the electron-ion receptor cathode: Preparing the cathode using the spin-coating method; using carbon cloth as the conductive substrate, mixing the electron-ion receptor cathode material, conductive carbon black, and polyvinylidene fluoride in a (6-8):(1-3):1 ratio in an agate mortar. Preferably, the ratio of cathode material, conductive carbon black, and polyvinylidene fluoride is 7:2:1. Adding N-methyl-2-pyrrolidone to the agate mortar and grinding for 15 minutes to form a slurry. Then, evenly spreading the slurry on the conductive carbon cloth (1*2 cm²). Finally, placing the conductive carbon cloth in a vacuum drying oven and dry for 10-15 hours. Preferably, the drying temperature in the vacuum oven is 100° C., and the drying time is 12 hours.

As a further explanation of this embodiment, in step (3), the electrolyte is: a sodium chloride solution of 0.01-2 M and organic pollutants.

As a further explanation of this embodiment, in step (4), the simulated light source has an AM1.5 spectrum with a radiance intensity of 100 mW/cm², equivalent to standard solar irradiance.

As a further explanation of this embodiment, the cathode material is selected from materials that simultaneously embed both ions and electrons, with the Gibbs free energy for ion embedding in the cathode material being less than zero (ΔG<0). Specifically, common materials include the positive electrode materials of water-based ion batteries, such as Na⁺ ion batteries, K⁺ ion batteries, or NH₄⁺ ion batteries.

As a further explanation of this embodiment, the photoanode material is selected to be an oxygen vacancies-enriched N-type semiconductor material. Specifically, the photoanode can be an electrode of oxygen vacancies-enriched TiO₂, WO₃, and BiVO₄, optimized through the preparation process.

As a further explanation of this embodiment, the radical generation reactions of the oxygen-vacancies-enriched photoanode include:

TiO₂/BiVO₄+hv→TiO₂/BiVO₄(e⁻+h+)

H₂O+h⁺→·OH+H⁺

Cl−+h⁺→·Cl

2Cl−→Cl₂+2e⁻

Cl₂+H₂O→H⁺+Cl⁻+HClO

As a further explanation of this embodiment, the chlorine radical generation reactions include:

·OH+HClO→·ClO+H₂O

·Cl+HClO→·ClO+OH⁻

h⁺+HClO→·ClO+OH⁻

The following provides further explanation through specific embodiments.

### Embodiment 1

As shown in FIG. 1, the bias-free driven ion-based photoelectrochemical wastewater treatment method in this embodiment uses oxygen vacancies-enriched titanium dioxide (TiO₂) as the photoanode, cobalt-iron Prussian blue (CoHCF)-loaded carbon cloth as the cathode, a quartz electrolytic cell containing simulated organic wastewater and electrolyte, and a xenon lamp light source simulating the solar spectrum. When illuminated, the TiO₂ electrode is excited by the simulated light source to generate electron-hole pairs. The CoHCF cathode has the function of simultaneously receiving electron-ion coupling. Photogenerated electrons can quickly flow to the cathode via the external circuit and simultaneously couple with cations in the electrolyte to transfer photogenerated electrons. Therefore, the holes left on the photoanode undergo water oxidation to form the strong oxidant ·OH, which then reacts with chloride ions to form free chlorine (hypochlorous acid, HClO). The free chlorine can be oxidized by h⁺, ·OH, or ·Cl to form ·ClO, resulting in the complete oxidation and mineralization of organic pollutants in the wastewater.

Specifically, the electrolyte is a 0.5 M sodium chloride solution with 10 ppm methylene blue organic pollutant.

Specifically, the simulated light source is AM1.5, with a radiance intensity of 100 mW/cm², equivalent to standard solar irradiance.

Specifically, the process for preparing the photoanode using the hydrothermal method is as follows:

(a) Preparation of an oxygen vacancies-enriched titanium dioxide (TiO₂) conductive glass photoanode using the hydrothermal and calcination methods: Ultrasonically cleaning purchased fluorine-doped SnO₂ conductive glass (FTO) in acetone, ethanol, and deionized water for 10-30 minutes each. Then, drying in a 70° C. oven, and after drying, testing with a digital multimeter and labeling the conductive side for later use. Next, adding 0.5 mL titanium tetraisopropoxide to a solution formed by 10 mL deionized water and 10 mL concentrated hydrochloric acid. After stirring for 10 minutes, transferring the solution to a 50 mL high-pressure vessel. Tilting the FTO substrate and place it in the high-pressure vessel with the conductive side facing down. Transferring the high-pressure vessel to a constant temperature oven and maintain it at 170° C. for 5 hours. After cooling to room temperature, taking out the FTO substrate with TiO₂ growth, rinsing alternately with deionized water and ethanol 2-3 times, and drying in an oven.

(b) Prepare a 0.2 M titanium tetrachloride (TiCl₄) solution: To prevent hydrolysis of TiCl₄, using concentrated hydrochloric acid (36%-38%) as the solvent; adding 1 mL of TiCl₄ to 47.2 mL of concentrated hydrochloric acid to form a 0.2 M TiCl₄ solution.

(c) Immersing the FTO substrate with TiO₂ growth obtained in step (a) into the 0.2 M TiCl₄ solution prepared in step (b); sealing the bottle and transfer the bottle to an 80° C. oven for 1 hour. Afterward, taking out the FTO substrate, wash with 99.9% anhydrous ethanol, and blow dry.

(d) Placing the TiO₂-coated FTO substrate from step (c) in a crucible, transferring the FTO substrate to a muffle furnace, and anneal at 550° C. for 3 hours, with a heating rate of 5° C./min. Allowing the FTO substrate to cool naturally, resulting in an oxygen vacancies-enriched titanium dioxide (TiO₂) photoanode.

Specifically, the process for selecting and preparing the cathode is as follows:

Preparing the cathode using the spin-coating method: Using carbon cloth as the conductive substrate, mixing cobalt-iron Prussian blue (CoHCF), conductive carbon black, and polyvinylidene fluoride in a 7:2:1 ratio in an agate mortar. Adding an appropriate amount of N-methyl-2-pyrrolidone to the agate mortar, and grinding for 15 minutes to form a slurry. Then, evenly spreading the slurry on the conductive carbon cloth (1*2 cm²). Finally, placing the conductive carbon cloth in a vacuum drying oven and dry at 100° C. for 12 hours, making the conductive carbon cloth for use as the electrode.

Inserting the oxygen vacancies-enriched titanium dioxide (TiO₂) photoanode CoHCF cathode into a 0.5 M sodium chloride solution containing 10 ppm methylene blue organic pollutant. Illuminate the TiO₂ photoanode with a simulated light source, exciting the photoelectrocatalytic process. Water oxidation occurs to generate the strong oxidant ·OH, which then reacts with chloride ions to form free chlorine (HClO). The free chlorine can be oxidized by h⁺, ·OH, or ·Cl to form ·ClO, resulting in the complete oxidation and mineralization of organic pollutants in the wastewater.

This embodiment achieves a decolorization rate of 99% for methylene blue and a total organic carbon removal rate of 68% within 10 minutes.

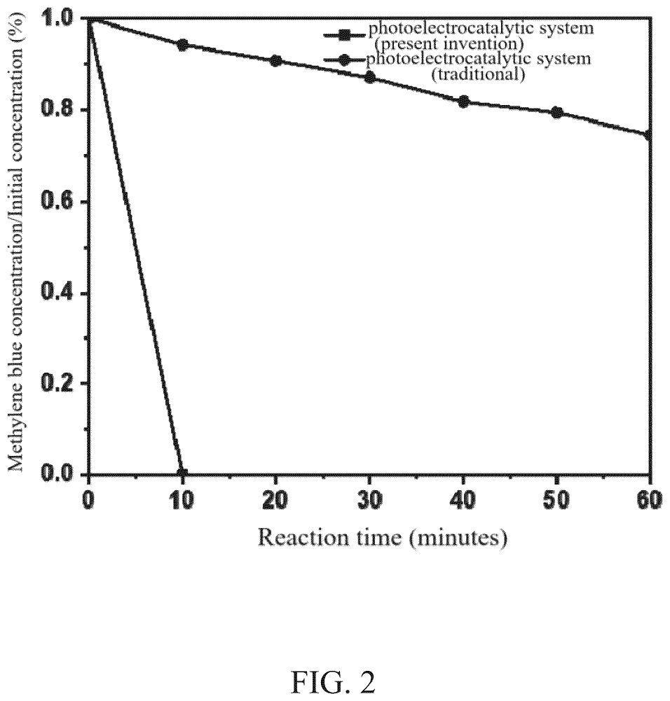

As shown in FIG. 2, using a traditional photoelectrochemical organic pollutant removal system with oxygen vacancies-enriched TiO₂ photoanode and a standard platinum sheet electrode as the cathode, under the same conditions, the decolorization rate of methylene blue is only 25.5%, and the total organic carbon removal rate is 7.2%.

### Embodiment 2

Compared with Embodiment 1, in this embodiment, the electrolyte used is a sodium chloride solution of 0.01-2 M with 10 ppm methylene blue organic pollutant.

The simulated light source is AM 1.5, with a radiance intensity of 100 mW/cm², equivalent to standard solar irradiance.

Specifically, the bias-free driven ion-based photoelectrochemical wastewater treatment method includes the following steps:

Inserting the oxygen vacancies-enriched titanium dioxide (TiO₂) photoanode and the CoHCF cathode into a 0.01-2 M sodium chloride solution containing 10 ppm methylene blue organic pollutant. Illuminating the TiO₂ photoanode with a simulated light source, exciting the photoelectrocatalytic process. Water oxidation occurs to generate the strong oxidant ·OH, which then reacts with chloride ions to form free chlorine (HClO). The free chlorine can be oxidized by h⁺, ·OH, or ·Cl to form ·CIO, resulting in the complete oxidation and mineralization of organic pollutants in the wastewater.

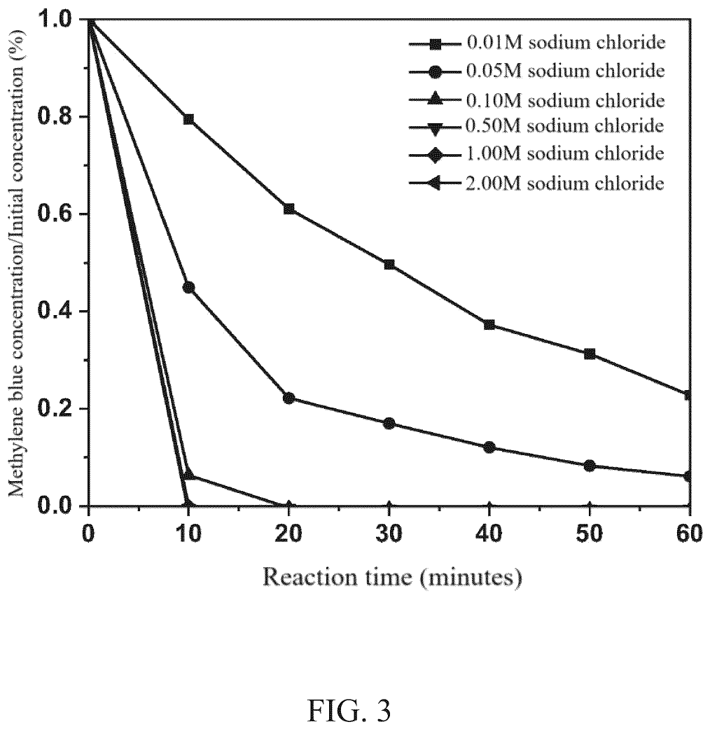

As shown in FIG. 3, this embodiment compares the removal effect of photoelectrochemical-mediated chlorine radical degradation of organic pollutants at different chloride ion electrolyte concentrations. Under the same conditions, as the chloride ion concentration increases, the decolorization rate of methylene blue increased from 77.3% to 99%, and the total organic carbon removal rate reached 62.5%.

### Embodiment 3

Compared with Embodiment 1, in this embodiment, the electrolyte used is a 0.5 M sodium chloride solution with 10 ppm carbamazepine organic pollutant.

The simulated light source is AM 1.5, with a radiance intensity of 100 mW/cm², equivalent to standard solar irradiance.

Specifically, the ion-based photoelectrochemical wastewater treatment method without bias voltage includes the following steps:

Inserting the oxygen-vacancies-enriched titanium dioxide (TiO₂) photoanode and the CoHCF cathode into a 0.5 M sodium chloride solution containing 10 ppm carbamazepine organic pollutant. Illuminating the TiO₂ photoanode with a simulated light source, exciting the photoelectrocatalytic process. Water oxidation occurs to generate the strong oxidant ·OH, which then reacts with chloride ions to form free chlorine (HClO). The free chlorine can be oxidized by h⁺, ·OH, or ·Cl to form ·CIO, resulting in the complete oxidation and mineralization of organic pollutants in the wastewater.

This embodiment achieves a degradation rate of 99% for carbamazepine and a total organic carbon removal rate of 63% within 10 minutes.

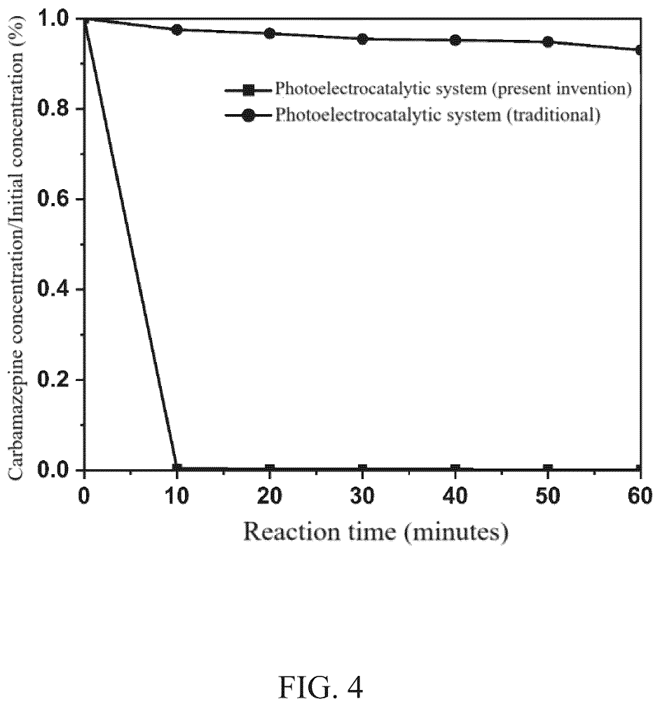

As shown in FIG. 4, using a traditional photoelectrochemical organic pollutant removal system with oxygen vacancies-enriched TiO₂ photoanode and a standard platinum sheet electrode as the cathode, under the same conditions, the removal rate of carbamazepine is only 7%, and the total organic carbon removal rate is 2%.

The present invention achieves efficient treatment of high-salinity wastewater through the ion-coupling photogenerated electron-assisted photocatalytic oxidation-reduction pathway. The system uses electron-ion receptor materials as the counter electrode, providing reaction sites for driving the coupling and cation transfer of photogenerated electrons. Additionally, the voltage generated by the system can directly drive hole oxidation to produce strong oxidizing free radicals. Furthermore, this ion-based photoelectrochemical system demonstrates excellent degradation performance in high-concentration chloride media. This suggests that, in addition to cations (such as Na⁺), which help accelerate the electron transfer rate, the presence of Cl further enables efficient and sustainable wastewater treatment. The concept proposed in this invention highlights the potential for using abundant sodium chloride in seawater as an inexpensive additive for wastewater treatment.

The above embodiments are specific implementations of the present invention, but the technical features of the invention are not limited to these. Any simple modifications, equivalent substitutions, or adjustments made based on the present invention to solve similar technical problems and achieve similar technical effects are included within the scope of protection of the present invention.

What is claimed is:

1. A bias-free driven ion-based photoelectrochemical wastewater treatment system, comprising a photoanode, a cathode, a quartz electrolytic cell containing an electrolyte, and a xenon lamp light source simulating the solar spectrum; the photoanode is an electrode made of an oxygen vacancies-enriched N-type semiconductor, and the cathode is an electrode made of an electron-ion receptor material; the photoanode and cathode are inserted at both ends of the quartz electrolytic cell, and an external circuit wire is provided between the photoanode and cathode;
when illuminated, the photoanode is excited by the simulated light source from the xenon lamp to generate electron-hole pairs; the cathode made of electron-ion receptor material has the function of simultaneously receiving coupled electrons and ions; photogenerated electrons quickly flow to the cathode via the external circuit while coupling with cations in the electrolyte to achieve the transfer of photogenerated electrons.

2. A method for bias-free driven ion-based photoelectrochemical wastewater treatment, comprising the following steps:
(1) selection and preparation of a photoanode: selecting an oxygen vacancies-enriched N-type semiconductor and preparing a photoelectrode made of the oxygen vacancies-enriched N-type semiconductor via a hydrothermal or electroplating method;
(2) selection and preparation of a cathode: selecting a material that has the function of simultaneously embedding ions and electrons, and preparing the cathode made of electron-ion receptor material by spin coating;
(3) installation of a reaction device: inserting the photoanode and cathode into two ends of a quartz electrolytic cell containing an electrolyte, where the quartz electrolytic cell holds organic wastewater; providing an external circuit wire between the photoanode and cathode to form the reaction device.
(4) perform photoelectrochemical reaction using the reaction device: illuminating the photoanode with the xenon lamp light source simulating the solar spectrum; the simulated light source from the xenon lamp excites the generation of electron-hole pairs; the cathode, made of electron-ion receptor material, simultaneously receives coupled electrons and ions; photogenerated electrons quickly flow to the cathode through the external circuit while coupling with cations in the electrolyte to transfer photogenerated electrons; the holes left on the photoanode undergo water oxidation to form strong oxidizing agents (·OH); then reacting with chloride ions to form free chlorine, which is oxidized by h⁺, ·OH, or ·Cl to form ·CIO, thereby oxidizing and mineralizing organic pollutants in the wastewater.

3. The method for bias-free driven ion-based photoelectrochemical wastewater treatment according to claim 2, wherein in step (1), the selection process of the photoanode is as follows: selecting the oxygen vacancies-enriched N-type semiconductor as the photoanode; the photogenerated holes in the valence band of the photoanode are more positive than the oxidation potential of halide ions to halogen radicals.

4. The method for bias-free driven ion-based photoelectrochemical wastewater treatment according to claim 2, wherein the process for preparing the photoanode using a hydrothermal method in step (1) is as follows:
(a) preparation of an oxygen vacancies-enriched titanium dioxide conductive glass photoanode using the hydrothermal method: ultrasonically cleaning FTO substrate in acetone, ethanol, and deionized water for 10-30 minutes each, then drying the cleaned FTO substrate in an oven at 60-80° C.; after drying, testing the dried FTO substrate with a digital multimeter and labeling a conductive side for later use; then adding titanium tetraisopropoxide to a mixed solution of deionized water and concentrated hydrochloric acid; after stirring, transferring the solution to a high-pressure vessel; tilting the FTO substrate and placing the FTO substrate high-pressure vessel with the conductive side facing down; transferring the high-pressure vessel to a constant temperature oven and maintain it at 60-80° C. for 4-8 hours; taking out the high-pressure vessel to cool to room temperate; once the high-pressure vessel cools to room temperature, fetching the FTO substrate with TiO₂ growth, rinsing the FTO substrate alternately with deionized water and ethanol 2-3 times, and drying the rinsed FTO substrate in an oven;
(b) preparation of a 0.2 M titanium tetrachloride solution: using concentrated hydrochloric acid (36%-38%) as the solvent and adding titanium tetrachloride to the concentrated hydrochloric acid to form the 0.2 M titanium tetrachloride solution;
(c) immersing the FTO substrate with TiO₂ growth obtained in step (a) into the 0.2 M titanium tetrachloride solution prepared in step (b); sealing the bottle and transfer the bottle to an oven for 0.5-1.5 hours; taking out the FTO substrate and washing the FTO substrate with 99.9% anhydrous ethanol before blowing dry; and
(d) placing the TiO₂-coated FTO substrate from step (c) into a crucible, transferring the crucible to a muffle furnace, and annealing the FTO substrate at 500-600° C. for 2.5-3.5 hours with a heating rate of 5° C./min; after natural cooling, the oxygen vacancies-enriched TiO₂ photoanode is obtained.

5. The method for bias-free driven ion-based photoelectrochemical wastewater treatment according to claim 2, wherein the process for preparing the photoanode using an electroplating method in step (1) is as follows:
(a) preparation of an oxygen vacancies-enriched bismuth vanadate conductive glass photoanode using the hydrothermal method: ultrasonically cleaning the FTO substrate in acetone, ethanol, and deionized water for 10-30 minutes each, then drying the cleaned FTO substrate in an oven at 60-80° C.; after drying, testing the FTO substrate with a digital multimeter and label the conductive side of the FTO substrate for later use; next, mixing 0.4 M potassium iodide solution with concentrated nitric acid solution to adjust the pH to 1.6; then, adding 0.04 M Bi(NO3)3·5H₂O, stirring strongly, and obtaining a transparent KI/Bi(NO3)3 solution;
(b) adding p-benzoquinone into the KI/Bi(NO3)3 solution obtained in step (a); stirring, and then filtering with a water-based filter membrane and syringe; in a three-electrode system consisting of saturated mercury and Pt electrode and FTO substrate, applying a −0.144 V_{SCE} bias for 90-150 seconds to electrodeposit a BiOI film;
(c) preparing a 0.2 M VO(acac)2 solution in DMSO (Dimethyl Sulphoxide) and obtain a clear solution after ultrasonic treatment; dropping 55 μL/cm² of the DMSO solution onto the BiOI film from step (b) and placing the BiOI film flat in a rectangular quartz boat without a lid; transferring the rectangular quartz boat to a muffle furnace and heat at a rate of 2° C./min to 400-500° C.; maintaining for 1.5-2.5 hours and then allow rectangular quartz boat to cool naturally; and
(d) immersing the electrode obtained in step (c) in 1.0 M KOH, stirring the KOH slowly for 10-20 minutes to remove the byproduct V2O5 impurities from the electrode surface, resulting in an oxygen vacancies-enriched bismuth vanadate photoanode.

6. The method for bias-free driven ion-based photoelectrochemical wastewater treatment according to claim 2, in step (2), the process for selecting and preparing the cathode is as follows:
(2.1) selection of the electron-ion receptor cathode: selecting a material capable of simultaneously embedding ions and electrons, where the Gibbs free energy for ion embedding in the cathode material is less than zero;
(2.2) preparation of the electron-ion receptor cathode: preparing the cathode using the spin-coating method; using carbon cloth as a conductive substrate, and mixing the electron-ion receptor cathode material, conductive carbon black, and polyvinylidene fluoride in a (6-8): (1-3):1 ratio in an agate mortar; adding N-methyl-2-pyrrolidone into the agate mortar and grinding the electron-ion receptor cathode material, the conductive carbon black, the polyvinylidene fluoride, and the N-methyl-2-pyrrolidone in the agate mortar to form a slurry; then evenly coating the slurry onto the conductive carbon cloth and dry the conductive carbon cloth in a vacuum oven for 10-15 hours.

7. The method for bias-free driven ion-based photoelectrochemical wastewater treatment according to claim 2, in step (3), the electrolyte is a solution of 0.01-2 M sodium chloride and organic pollutants.

8. The method for bias-free driven ion-based photoelectrochemical wastewater treatment according to claim 2, in step (4), the simulated light source has an AM1.5 spectrum and an irradiance of 100 mW/cm2, equivalent to standard solar irradiance.

9. The method for bias-free driven ion-based photoelectrochemical wastewater treatment according to claim 2, the cathode is the positive material of a water-based ion battery such as Na+, K+, or NH4+ ion battery.

10. The method for bias-free driven ion-based photoelectrochemical wastewater treatment according to claim 2, wherein the photoanode is an electrode of oxygen vacancies-enriched TiO2, WO3, and BiVO4, optimized through the preparation process.
